(19) United States
(12) Patent Application Publication
(10) Pub. No.: US 2025/0055752 A1
(43) Pub. Date: Feb. 13, 2025

(54) SYSTEM AND METHOD FOR AUTOMATED NODE FAILURE DETECTION ACROSS A MULTI-NODE NETWORK

(71) Applicant: BANK OF AMERICA CORPORATION, Charlotte, NC (US)

(72) Inventors: Elvis Nyamwange, Little Elm, TX (US); Sailesh Vezzu, Hillsborough, NJ (US); Amer Ali, Jersey City, NJ (US); Rahul Shashidhar Phadnis, Charlotte, NC (US); Rahul Yaksh, Austin, TX (US); Hari Vuppala, Concord, NC (US); Pratap Dande, Saint Johns, FL (US); Brian Neal Jacobson, Los Angeles, CA (US); Erik Dahl, Newark, DE (US)

(73) Assignee: BANK OF AMERICA CORPORATION, Charlotte, NC (US)

(21) Appl. No.: 18/231,707

(22) Filed: Aug. 8, 2023

(51) Int. Cl. H04L 41/0668; H04L 41/0604; H04L 41/22

(52) U.S. Cl. CPC H04L 41/0668; H04L 41/0627; H04L 41/22

(57) ABSTRACT

Systems, computer program products, and methods for automated node failure detection across a multi-node network. The method includes receiving one or more node metrics. Each of the one or more node metrics are associated with a node of a distributed network with a plurality of nodes. The method also includes determining a potential failure node of the plurality of nodes based on at least one of the one or more node metrics. The potential failure node is the node associated with the at least one of the one or more node metrics. The at least one of the one or more node metrics is different than an expected node metric for the node. The method further includes determining one or more replacement nodes for the potential failure node. The one or more replacement nodes are capable of performing one or more operations being performed by the potential failure node. The method still further includes causing the one or more replacement nodes to replace one or more operations of the potential failure node.

### TECHNOLOGICAL FIELD

Example embodiments of the present disclosure relate generally to network failure detection and, more particularly, to automated node failure detection across a multi-node network.

### BACKGROUND

Network operations are often interrupted and/or halted due to component failure. Additionally, distributed networks introduce even more components to fail during network operations. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

In an example embodiment, a system for automated node failure detection across a multi-node network is provided. The system includes at least one non-transitory storage device containing instructions and at least one processing device coupled to the at least one non-transitory storage device. The at least one processing device, upon execution of the instructions, is configured to receive one or more node metrics. Each of the one or more node metrics are associated with a node of a distributed network with a plurality of nodes. The at least one processing device, upon execution of the instructions, is also configured to determine a potential failure node of the plurality of nodes based on at least one of the one or more node metrics. The potential failure node is the node associated with the at least one of the one or more node metrics. The at least one of the one or more node metrics is different than an expected node metric for the node. The at least one processing device, upon execution of the instructions, is further configured to determine one or more replacement nodes for the potential failure node. The one or more replacement nodes are capable of performing one or more operations being performed by the potential failure node. The at least one processing device, upon execution of the instructions, is still further configured to cause the one or more replacement nodes to replace one or more operations of the potential failure node.

In various embodiments, the at least one processing device, upon execution of the instructions, is configured to cause a rendering of a user graphical interface with information relating to at least one of the potential failure node or at least one of the one or more replacement nodes.

In various embodiments, the at least one processing device, upon execution of the instructions, is configured to generate the expected node metric for a node based on previous network operations. In various embodiments, the at least one of the one or more node metrics is different than an expected node metric for the node in an instance in which the at least one of the one or more node metrics is outside of a historic range based on previous network operations.

In various embodiments, the at least one processing device, upon execution of the instructions, is configured to cause an investigation action to be executed on the potential failure node to remedy any error in the potential failure node. In various embodiments, the at least one processing device, upon execution of the instructions, is configured to determine if the potential failure node is operational upon completion of the investigation action and cause the potential failure node to be activated for the one or more operations in an instance in which the potential failure node is operational.

In various embodiments, at least one of the one or more replacement nodes is a standby node that is not operational in an instance in which each of the plurality of nodes are operational. In various embodiments, at least one of the one or more replacement nodes is one of the plurality of nodes.

In another example embodiment, a computer program product for automated node failure detection across a multi-node network is provided. The computer program product comprising at least one non-transitory computer-readable medium having computer-readable program code portions embodied therein. The computer-readable program code portions include one or more executable portions configured to receive one or more node metrics. Each of the one or more node metrics are associated with a node of a distributed network with a plurality of nodes. The computer-readable program code portions include one or more executable portions also configured to determine a potential failure node of the plurality of nodes based on at least one of the one or more node metrics. The potential failure node is the node associated with the at least one of the one or more node metrics. The at least one of the one or more node metrics is different than an expected node metric for the node. The computer-readable program code portions include one or more executable portions further configured to determine one or more replacement nodes for the potential failure node. The one or more replacement nodes are capable of performing one or more operations being performed by the potential failure node. The computer-readable program code portions include one or more executable portions still further configured to cause the one or more replacement nodes to replace one or more operations of the potential failure node.

In various embodiments, the computer-readable program code portions include one or more executable portions also configured to cause a rendering of a user graphical interface with information relating to at least one of the potential failure node or at least one of the one or more replacement nodes.

In various embodiments, the computer-readable program code portions include one or more executable portions also configured to generate the expected node metric for a node based on previous network operations. In various embodiments, the at least one of the one or more node metrics is different than an expected node metric for the node in an instance in which the at least one of the one or more node metrics is outside of a historic range based on previous network operations.

In various embodiments, the computer-readable program code portions include one or more executable portions also configured to cause an investigation action to be executed on the potential failure node to remedy any error in the potential failure node. In various embodiments, the computer-readable program code portions include one or more executable portions also configured to determine if the potential failure node is operational upon completion of the investigation action and cause the potential failure node to be activated for the one or more operations in an instance in which the potential failure node is operational.

In various embodiments, at least one of the one or more replacement nodes is a standby node that is not operational in an instance in which each of the plurality of nodes are operational. In various embodiments, at least one of the one or more replacement nodes is one of the plurality of nodes.

In still another example embodiment, a method for automated node failure detection across a multi-node network is provided. The method includes receiving one or more node metrics. Each of the one or more node metrics are associated with a node of a distributed network with a plurality of nodes. The method also includes determining a potential failure node of the plurality of nodes based on at least one of the one or more node metrics. The potential failure node is the node associated with the at least one of the one or more node metrics. The at least one of the one or more node metrics is different than an expected node metric for the node. The method further includes determining one or more replacement nodes for the potential failure node. The one or more replacement nodes are capable of performing one or more operations being performed by the potential failure node. The method still further includes causing the one or more replacement nodes to replace one or more operations of the potential failure node.

In various embodiments, the method also includes causing a rendering of a user graphical interface with information relating to at least one of the potential failure node or at least one of the one or more replacement nodes. In various embodiments, the method also includes generating the expected node metric for a node based on previous network operations with the at least one of the one or more node metrics being different than an expected node metric for the node in an instance in which the at least one of the one or more node metrics is outside of a historic range based on previous network operations.

In various embodiments, the method also includes determining if the potential failure node is operational upon completion of an investigation action and causing the potential failure node to be activated for the one or more operations in an instance in which the potential failure node is operational.

In various embodiments, at least one of the one or more replacement nodes is a standby node that is not operational in an instance in which each of the plurality of nodes are operational. In various embodiments, at least one of the one or more replacement nodes is one of the plurality of nodes.

The features, functions, and advantages that have been discussed may be achieved independently in various embodiments of the present disclosure or may be combined with yet other embodiments, further details of which can be seen with reference to the following description and drawings.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automated node failure detection across a multi-node network, in accordance with various embodiments of the present disclosure;

FIG. 2 illustrates an example machine learning (MIL) subsystem architecture used to detect automated node failure across a multi-node network, in accordance with various embodiments of the present disclosure; and

FIGS. 3A and 3B illustrate a process flow for automated node failure detection across a multi-node network, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the various inventions may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Network operations are often interrupted and/or halted due to component failure. As networks have become more distributed across different devices on a network, more components are part of the network, resulting in more failure points for the network. As such, the number of components can be difficult to monitor and detect potential failures. Node failure can cause parts or all of the network to be non-functional. For example, a network (e.g., a centralized blockchain network) may have multiple nodes, such as routers, modems, switches, hubs, servers, local traffic managers (LTMs), global traffic managers (GTMs), remote database servers, and/or other devices on the network, which can fail or otherwise be offline at any time. As such, in an instance in which a node is offline, the network operations may be limited, which may affect network accuracy, speed, security, and/or the like.

Various embodiments of the present disclosure allow for automated node failure detection across a multi-node network. The system uses prior network operations to determine expected node metrics for nodes in the network via AI modeling. The system receives node metrics for the nodes during the network operations and determines a potential failure node based on a comparison between the expected node metric and the actual node metric. The potential failure node may be replaced in the network by one or more replacement nodes, while the potential failure node is investigated, replaced, fixed, etc. Upon correcting any issues with the potential failure node, the potential failure node may be reactivated on the network and resume performing operations on the network.

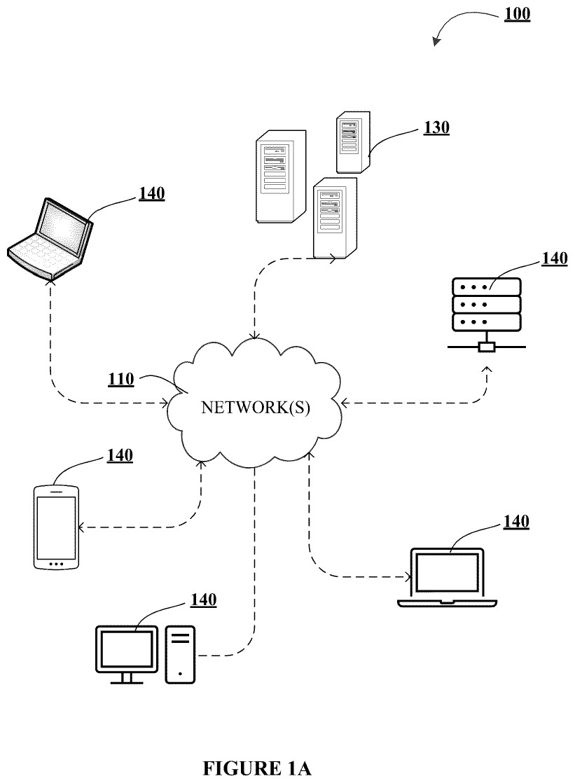

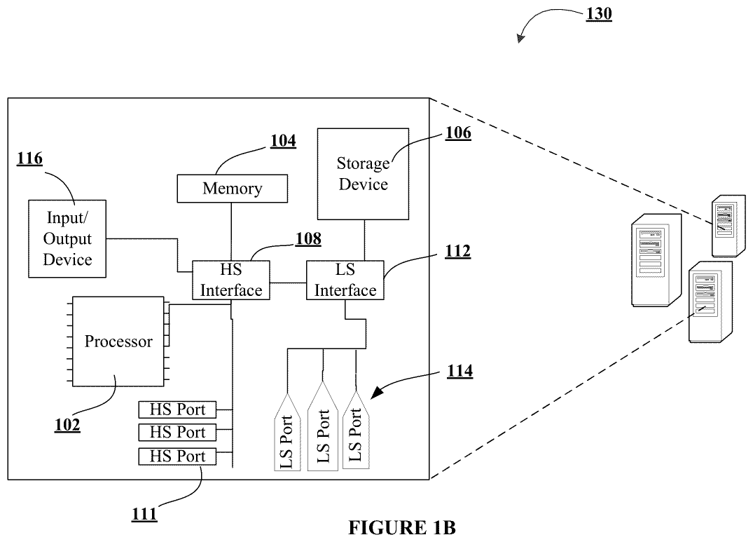

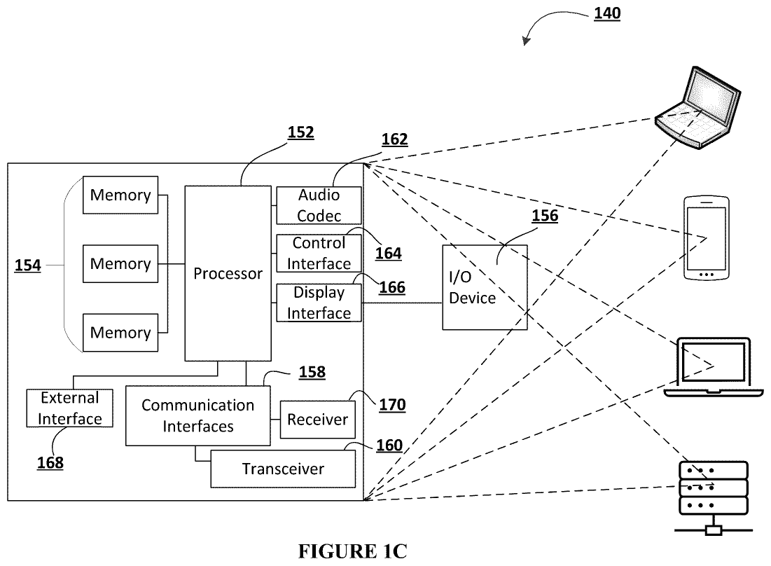

FIGS. 1A-1C illustrate technical components of an exemplary distributed computing environment for automated node failure detection across a multi-node network, in accordance with various embodiments of the disclosure. As shown in FIG. 1A, the distributed computing environment 100 contemplated herein may include a system 130 (e.g., a node failure detection device), an end-point device(s) 140, and one or more networks 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network(s) 110. Instead of having a central server (e.g., system 130) which would act as the shared drive, each device that is connect to the network(s) 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network(s) 110 may be a distributed network that is spread over different networks. This provides a single data communication network, which can be managed jointly or separately by each network. Besides shared communication within the network, the distributed network often also supports distributed processing. The network(s) 110 may be a form of digital communication network such as a telecommunication network, a local area network (“LAN”), a wide area network (“WAN”), a global area network (“GAN”), the Internet, satellite network, cellular network, and/or any combination of the foregoing. The network(s) 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosure described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed expansion port 114 (shown as “LS Port”) and storage device 106. Each of the components 102, 104, 106 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interfaces 158, and a transceiver 160, among other components. The end-point device(s) 140 may also be provided with a storage device, such as a micro-drive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single in Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network(s) 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through at least one of communication interfaces 158, which may include digital signal processing circuitry where necessary. Communication interfaces 158 may provide for communications under various modes or protocols, such as the Internet Protocol (IP) suite (commonly known as TCP/IP). Protocols in the IP suite define end-to-end data handling methods for everything from packetizing, addressing, and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interfaces 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130. The end-point device(s) 140 may include a communication interface that is configured to operate with a satellite network.

In various embodiments, the end-point device(s) 140 may have multiple communication interfaces that are configured to operate using the various communication methods discussed herein. For example, an end-point device 140 may have a cellular network communication interface (e.g., a communication interface that provides for communication under various telecommunications standards) and a satellite network communication interface (e.g., a communication interface that provides for communication via a satellite network). Various other communication interfaces may also be provided by the end-point device (e.g., an end-point device may be capable of communicating via a cellular network, a satellite network, and/or a wi-fi connection). Various communication interfaces may share components with other communication interfaces in the given end-point device.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

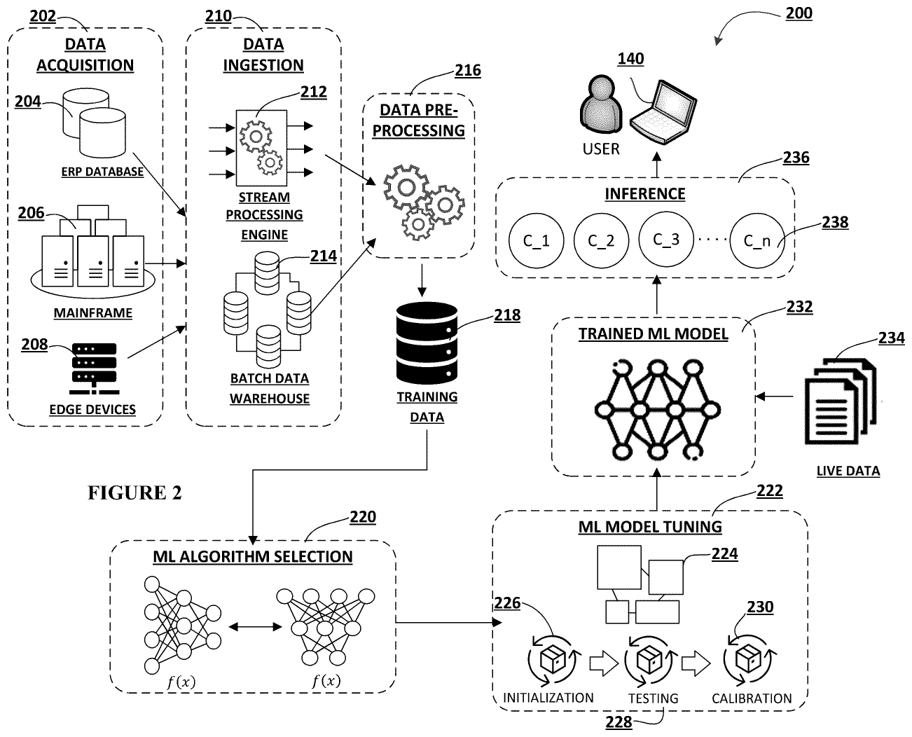

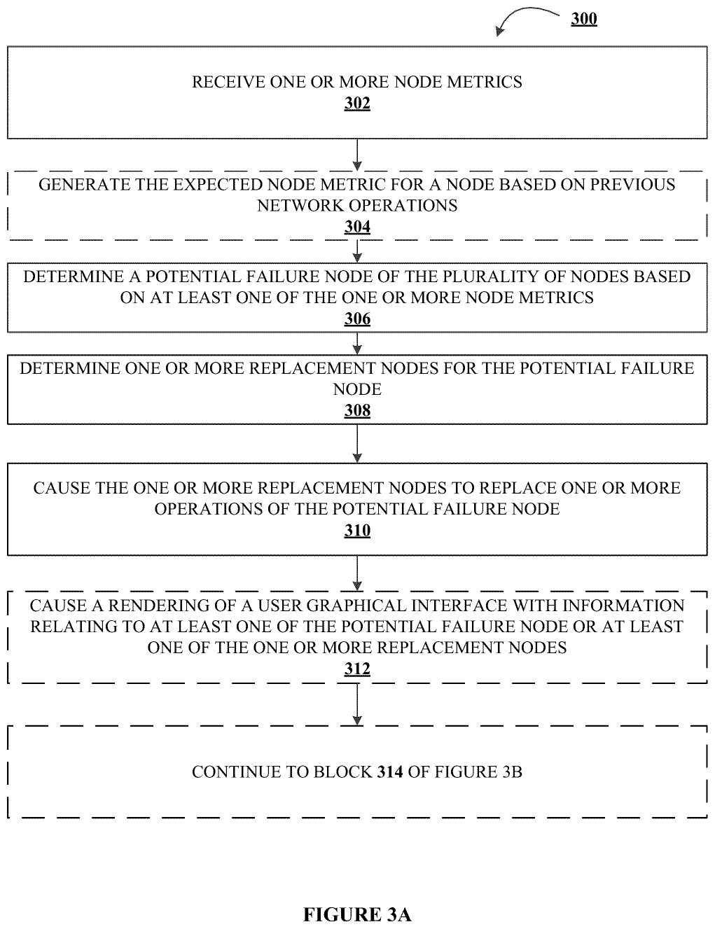

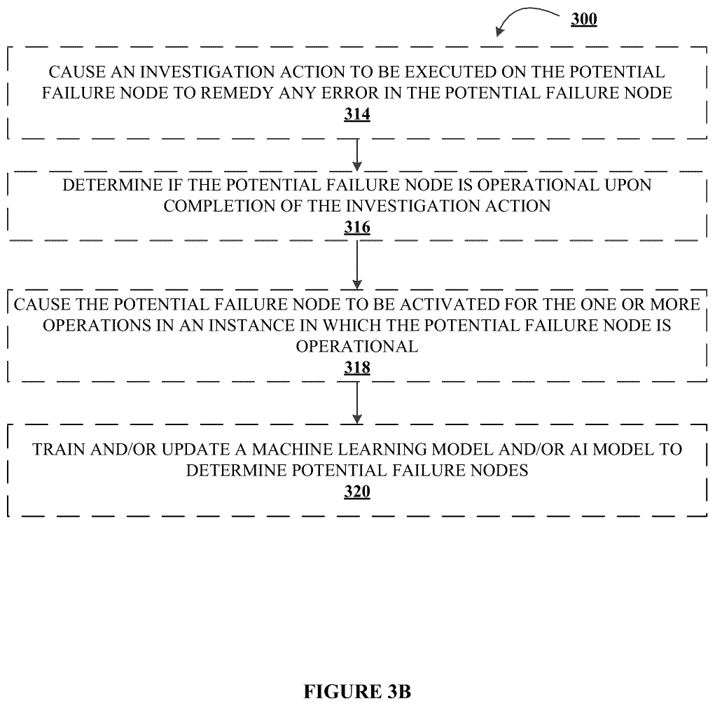

FIG. 2 illustrates an example machine learning (ML) architecture 200, in accordance with an embodiment of the present disclosure. The ML subsystem architecture may be part of the components of the environment 100 (e.g., system 130). The ML subsystem architecture is used to detect and prevent malfeasant targeting of individual users in a network as discussed below in reference to FIGS. 3A and 3B. Namely, the ML subsystem architecture may be used to train the system to determine potential failure nodes.

The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 210, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is example and that other embodiments may vary. As another example, in some embodiments, the machine learning subsystem 200 may include more, fewer, or different components.

FIGS. 3A and 3B include a flow chart 300 that illustrates an example method for automated node failure detection across a multi-node network. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein. A method of various embodiments may include any combination or subset of the features discussed herein.

Referring now to Block 302 of FIG. 3A, the method includes receiving one or more node metrics. Each of the one or more node metrics are associated with a node of a distributed network with a plurality of nodes. A node may be any device on a network that performs any operations on the network, such as routers, modems, switches, hubs, servers, local traffic managers (LTMs), global traffic managers (GTMs), remote database servers, and/or other devices on the network. In an example in which the network is a distributed computing network, each node may perform one or more operations for the network.

In various embodiments, a node metric may be any indictor that relates to the status of a node. For example, the node metric may include component heat, speed, usage, bandwidth, availability, and/or the like. In various embodiments, the node metric may be a metric of the node already being monitored (e.g., a server may have a meter for internal heat and the server may transmit the value to the system for determinations discussed herein). Additionally or alternatively, node metrics may be generated specifically for the system. The node metrics may be based on recommended operating conditions for a given node. For example, a manufacturer of a node device may recommend operating speeds and as such, the speed may be monitored to detect issues with the node device.

Referring now to optional Block 304 of FIG. 3A, the method includes generating the expected node metric for a node based on previous network operations. The expected node metric for the node may be based on previous node operations on the network or similar networks. For example, a node may be designated as a potential failure node in an instance in which the at least one of the one or more node metrics is outside of a historic range based on previous network operations. The historic range may be a range of the node metric in which the node has operated correctly. In various embodiments, the historic range may also include a buffer to the historic range.

The expected node metric may be based on node operating recommendations of the given node. For example, a manufacturer may recommend specific node metric ranges (e.g., heat ranges, speed ranges, usage ranges, etc.) that the node should operate. As such, the system may use the node operating recommendations as expected node metrics.

In various embodiments, the expected node metric may be generated via AI modeling. As discussed below in reference to optional Block 320, the system may use ML/AI model(s) to generate expected node metrics for nodes of the network. The ML/AI model(s) may be trained using time series input data that may include internet bandwidth, electricity, data availability, data consistency, data loss, number of nodes, throughput, and/or the like. The ML/AI model(s) are trained to improve self-healing standby nodes, making the system faster and able to remediate an event before the failure happens.

Referring now to Block 306 of FIG. 3A, the method includes determining a potential failure node of the plurality of nodes based on at least one of the one or more node metrics. A node may be considered a potential failure node in any instance in which a node may be likely to be offline or going to be offline within a predetermined amount of time (e.g., due to failure, maintenance, replacement, etc.).

In various embodiments, a node may be designated as a potential failure node in an instance in which a node metric associated with the node is outside of an expected node metric value or range. For example, a node may be designated as a potential failure node in an instance in which the at least one of the one or more node metrics is different than an expected node metric for the node. The expected node metric for the node may be based on previous node operations on the network or similar networks. For example, a node may be designated as a potential failure node in an instance in which the at least one of the one or more node metrics is outside of a historic range based on previous network operations.

Referring now to Block 308 of FIG. 3A, the method includes determining one or more replacement nodes for the potential failure node. Each of the one or more replacement nodes are capable of performing one or more operations being performed by the potential failure node. The replacement node(s) may take over operations for part or all of the potential failure node. For example, depending on the type of potential failure, a node may remain partially online, while the affected portions of the node may be taken offline for repair and/or diagnostics. In various embodiments, multiple replacement nodes may be used to carry out the operations typically assigned to the potential failure node (e.g., the operations may be distributed across multiple nodes). Alternatively, a single replacement node may replace the operations of the potential failure node. For example, the potential failure node may be replaced by the same type of node (e.g., a server may be replaced by another server) capable of carrying out the same operations.

In various embodiments, one or more of the replacement node(s) may be a standby node that is not operational in an instance in which each of the plurality of nodes are operational. A standby node may be purely for instances in which one or more nodes are offline. As such, the standby node may be not powered or otherwise online during typical operations of the network. In an instance in which one of the replacement node(s) is a standby node, the standby node may be activated (e.g., powered on) before replacing the operation(s) of the potential failure node.

In various embodiments, one or more of the replacement node(s) may be another node of the plurality of nodes. As such, the replacement node may be operational for other operations and in an instance in which the potential failure node is offline, the replacement node may carry out operations that are assigned to the potential failure node in addition to normally assigned operations of the node. In various embodiments, one or more of the replacement node(s) may be another node of the plurality of nodes and one or more of the replacement node(s) may be a standby node.

Referring now to Block 310 of FIG. 3A, the method includes causing the one or more replacement nodes to replace one or more operations of the potential failure node. A replacement node replaces one or more operations of the potential failure node in an instance in which one or more operations typically assigned to the potential failure node on the network are instead assigned to the replacement node. For example, a server may be assigned with transmitting specific data in a network and in an instance in which the server is a potential failure node, the specific data may be instead transmitted by the replacement node(s).

In various embodiments, the replacement node(s) may be designated to replace the potential failure node for a predetermined amount of time. For example, the replacement node(s) may be operational for the rest of the day in order for diagnostics and/or repairs to be made on the potential failure node. In various embodiments, the replacement node(s) may be designated to replace the potential failure node until the potential failure node returns to a standard operating state. For example, the system may determine an investigation action fixed any issues with the potential failure node.

Referring now to optional Block 312 of FIG. 3A, the method includes causing a rendering of a user graphical interface with information relating to at least one of the potential failure node or at least one of the one or more replacement nodes. The user graphical interface may be rendered to one or more end-point devices associated with the network. For example, the user graphical interface may be rendered to one or more end-point devices associated with a developer or network administrator.

In various embodiments, the user graphical interface may include information relating to one or more nodes on the network (e.g., the status of each node may be displayed), potential failure nodes, stand-by nodes (e.g., nodes that may be used as replacement nodes), node metrics, and/or the like. The system may generate one or more reports relating to the network for access via the user graphical interface. For example, the report may include information relating to given nodes, such as node metrics, downtime, operations assigned to the node, etc.

Referring now to optional Block 314 of FIG. 3B, the method includes causing an investigation action to be executed on the potential failure node to remedy any error in the potential failure node. The investigation action may be automated. The investigation action may be a diagnostic operation (e.g., determining the issue causing the node to be designated as a potential failure node). In various embodiments, the investigation action may include determining whether the potential failure node is malfunctioning and/or otherwise needs repairs. For example, a node may be designated as a potential failure node in an instance in which the node is operating normal (e.g., a node metric may be caused by another malfunctioning node). In an instance in which the potential failure node is not malfunctioning and/or other needs repairs, the system may perform additional network diagnostics to determine the node(s) responsible for the change in the network (e.g., the system may monitor nodes that interact with the potential failure node). In such an instance, the operations herein may be repeated for any nodes that are detected as potentially failing.

In an instance in which the potential failure node is malfunctioning and/or otherwise needs repairs, the investigation action may also include determining a node remediation action for the potential failure node. The node remediation action may be any action to fix the potential failure node, such as hardware changes or replacement, software updates or changes, cycling the node (e.g., powering the node off and back on), and/or the like. The node remediation action may be determined based on previous malfunctioning nodes (e.g., using ML/AI models discussed herein).

In various embodiments, the node remediation action may be automated. For example, the system may replace a node permanently with another node in the network. In various embodiments, the node remediation action may require manual assistance. For example, a node module or other component of the node may need to be physically replaced. As such, the system may generate an alert to be transmitted to an end-point device associated with the network (e.g., a technician that is capable of replacing a part on the node). The system may then monitor the node to determine whether the part has been replaced.

Referring now to optional Block 316 of FIG. 3B, the method includes determining if the potential failure node is operational upon completion of the investigation action. The system may run one or more tests on the potential failure node to determine whether the potential failure node is operational. The one or more tests may be offline (e.g., the system may perform tests on the node outside of the network operations). For example, the system may simulate data transmissions that would typically be received and transmitted by the node in order to generate node metrics for the node. As such, the simulated node metrics may be compared to the node metrics and/or the expected node metrics to determined whether the node has been fixed.

In various embodiments, in an instance the potential failure node is operational, the node may be reactivated into the network (as discussed in Block 318 below). In such an example, the node metric(s) for the node may be monitored during the operations of the network (e.g., the system would return to Block 302 and begin monitoring the nodes again).

Referring now to optional Block 318 of FIG. 3B, the method includes causing the potential failure node to be activated for the one or more operations in an instance in which the potential failure node is operational. In various embodiments, any operations assigned or otherwise directed to the replacement node(s) in the operations of Block 310 are reassigned back to the potential failure node. As such, the replacement node(s) return to the previous state (e.g., stand-by nodes return to stand-by, and operating nodes return to just the typical operations for said node). The system may continue to monitor node(s) on the network as discussed herein.

In various embodiments, the potential failure node that is activated may be the node in the state after the investigation action (including any node remediation actions). For example, the potential failure node that is activated may be a new node that has replaced a malfunctioning node.

Referring now to optional Block 320 of FIG. 3B, the method includes training and/or updating a machine learning model and/or AI model to determine potential failure nodes. In various embodiments, the method may use any of the components of the ML architecture 200 shown and discussed above in reference to FIG. 2 to train and/or update the ML/AI model(s). In various embodiments, the ML/AI model(s) may be trained using time series input data that may include internet bandwidth, electricity, data availability, data consistency, data loss, number of nodes, throughput, and/or the like. The ML/AI model(s) are trained to improve self-healing standby nodes, making the system faster and able to remediate an event before the failure happens. The ML/AI model(s) may be trained using a training set including previous network operations for one or more nodes on the network. The ML/AI model(s) may be trained for multiple different nodes of the plurality of nodes. In various embodiments, the ML/AI model(s) may also be used in other operations herein. For example, a machine learning model may be used to determine node remediation actions for a potential failure node.

As will be appreciated by one of ordinary skill in the art, various embodiments of the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications, and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

1. A system for automated node failure detection across a multi-node network, the system comprising:
at least one non-transitory storage device containing instructions; and
at least one processing device coupled to the at least one non-transitory storage device, wherein the at least one processing device, upon execution of the instructions, is configured to:
receive one or more node metrics, wherein each of the one or more node metrics are associated with a node of a distributed network with a plurality of nodes, wherein the node of the distributed network comprises traffic managers within the distributed network;
based on at least one of the one or more node metrics, determine a potential failure node of the plurality of nodes, wherein the potential failure node is the node associated with the at least one of the one or more node metrics, wherein the at least one of the one or more node metrics is different than an expected node metric for the node;
determine one or more replacement nodes for the potential failure node, wherein the one or more replacement nodes are not online or powered on when the potential failure node is operational, wherein the one or more replacement nodes are pre-existing standby nodes within the distributed network; and
cause the one or more replacement nodes to perform one or more operations of the potential failure node.

2. The system of claim 1, wherein the at least one processing device, upon execution of the instructions, is configured to cause a rendering of a user graphical interface with information relating to at least one of the potential failure node or at least one of the one or more replacement nodes.

3. The system of claim 1, wherein the at least one processing device, upon execution of the instructions, is configured to generate the expected node metric for the node based on previous network operations.

4. The system of claim 3, wherein the at least one of the one or more node metrics is different than the expected node metric for the node in an instance in which the at least one of the one or more node metrics is outside of a historic range based on previous network operations.

5. The system of claim 1, wherein the at least one processing device, upon execution of the instructions, is configured to cause an investigation action to be executed on the potential failure node to remedy any error in the potential failure node.

6. The system of claim 5, wherein the at least one processing device, upon execution of the instructions, is configured to:
upon completion of the investigation action, determine if the potential failure node is operational; and
in an instance in which the potential failure node is operational, cause the potential failure node to be reactivated for the one or more operations, wherein the reactivation of the potential failure node comprises operations assigned to the one or more replacement nodes being reassigned back to the potential failure node and placing the replacement nodes in the not online or powered on state.

7. (canceled)

8. (canceled)

9. A computer program product for automated node failure detection across a multi-node network, the computer program product comprising at least one non-transitory computer-readable medium having computer-readable program code portions embodied therein, the computer-readable program code portions comprising one or more executable portions configured to:
receive one or more node metrics, wherein each of the one or more node metrics are associated with a node of a distributed network with a plurality of nodes, wherein the node of the distributed network comprises traffic managers within the distributed network;
based on at least one of the one or more node metrics, determine a potential failure node of the plurality of nodes, wherein the potential failure node is the node associated with the at least one of the one or more node metrics, wherein the at least one of the one or more node metrics is different than an expected node metric for the node;
determine one or more replacement nodes for the potential failure node, wherein the one or more replacement nodes are not online or powered on when the potential failure node is operational, wherein the one or more replacement nodes are pre-existing standby nodes within the distributed network; and
cause the one or more replacement nodes to perform one or more operations of the potential failure node.

10. The computer program product of claim 9, wherein the computer-readable program code portions comprising one or more executable portions are also configured to cause a rendering of a user graphical interface with information relating to at least one of the potential failure node or at least one of the one or more replacement nodes.

11. The computer program product of claim 9, wherein the computer-readable program code portions comprising one or more executable portions are also configured to generate the expected node metric for the node based on previous network operations.

12. The computer program product of claim 11, wherein the at least one of the one or more node metrics is different than the expected node metric for the node in an instance in which the at least one of the one or more node metrics is outside of a historic range based on previous network operations.

13. The computer program product of claim 9, wherein the computer-readable program code portions comprising one or more executable portions are also configured to cause an investigation action to be executed on the potential failure node to remedy any error in the potential failure node.

14. The computer program product of claim 13, wherein the computer-readable program code portions comprising one or more executable portions are also configured to:
upon completion of the investigation action, determine if the potential failure node is operational; and
in an instance in which the potential failure node is operational, cause the potential failure node to be reactivated for the one or more operations, wherein the reactivation of the potential failure node comprises operations assigned to the one or more replacement nodes being reassigned back to the potential failure node and placing the replacement nodes in the not online or powered on state.

15. (canceled)

16. (canceled)

17. A method for automated node failure detection across a multi-node network, the method comprising:
receiving one or more node metrics, wherein each of the one or more node metrics are associated with a node of a distributed network with a plurality of nodes, wherein the node of the distributed network comprises traffic managers within the distributed network;
based on at least one of the one or more node metrics, determining a potential failure node of the plurality of nodes, wherein the potential failure node is the node associated with the at least one of the one or more node metrics, wherein the at least one of the one or more node metrics is different than an expected node metric for the node;
determining one or more replacement nodes for the potential failure node, wherein the one or more replacement nodes are not online or powered on when the potential failure node is operational, wherein the one or more replacement nodes are pre-existing standby nodes within the distributed network; and
causing the one or more replacement nodes to perform one or more operations of the potential failure node.

18. The method of claim 17, further comprising causing a rendering of a user graphical interface with information relating to at least one of the potential failure node or at least one of the one or more replacement nodes.

19. The method of claim 17, further comprising generating the expected node metric for the node based on previous network operations, wherein the at least one of the one or more node metrics is different than the expected node metric for the node in an instance in which the at least one of the one or more node metrics is outside of a historic range based on previous network operations.

20. The method of claim 17, further comprising:
upon completion of an investigation action, determine if the potential failure node is operational; and
in an instance in which the potential failure node is operational, cause the potential failure node to be reactivated for the one or more operations, wherein the reactivation of the potential failure node comprises operations assigned to the one or more replacement nodes being reassigned back to the potential failure node and placing the replacement nodes in the not online or powered on state.

21. The system of claim 1, wherein the expected node metric comprises an expected node metric range of acceptable values, and wherein the one or more node metrics of the potential failure node is outside of the expected node metric range.

22. The system of claim 1, wherein the at least one processing device, upon execution of the instructions, is configured to:
determine, by an artificial intelligence (AI) model, an expected node metric for the node of the distributed network.
